(19) United States
(12) Patent Application Publication
(10) Pub. No.: US 2017/0208941 A1
(43) Pub. Date: Jul. 27, 2017

(54) System and Method of Using an Array of Actuated Furniture Partitions

(71) Applicant: Xnova Pty. Ltd., Hobart (AU)

(72) Inventor: Adnan Trakic, Hobart (AU)

(73) Assignee: Xnova Pty. Ltd., Hobart (AU)

(21) Appl. No.: 15/093,789

(22) Filed: Apr. 8, 2016

(30) Foreign Application Priority Data
Jan. 25, 2016 (AU) 2016200430

(51) Int. Cl. A47B 85/00; A61G 7/015; A61G 7/075; A61G 7/07; A47B 13/08; A47B 45/00; A47C 13/00; A47B 77/00; A47B 73/00; A47B 85/04; A47B 85/06; A47B 85/08; A47C 17/62; A63B 21/00; G05B 15/02; E04F 15/00; E04F 13/00; A47C 17/04

(52) U.S. Cl. CPC A47B 85/00; A47C 17/04; A61G 7/015; A61G 7/0755; A61G 7/07; A47B 13/081; A47B 45/00; A47C 13/005; A47B 77/00; A47B 73/00; A47B 13/088; A47B 85/04; A47B 85/06; A47B 85/08; A47C 17/62; A63B 21/4041; G05B 15/02; E04F 15/00; E04F 13/00

(57) ABSTRACT

The present invention relates to a new type of furniture, which can be reconfigured into an arbitrarily large number of shapes. The changing of furniture shape is accomplished with an array of individually driven actuators which are used to displace a set of furniture components (or modules) in particular spatial amount in order to cause an overall yet arbitrary furniture shape (or look).

### CROSS-REFERENCE TO RELATED APPLICATIONS

This application claims the benefit of the Non-Provisional Application No. 2016200430 (Australia), filed Jan. 25, 2016, and in chain priority cross-reference, the additional benefit of the Provisional Application No. 2015900243 (Australia), filed Jan. 28, 2015.

### TECHNICAL FIELD

The present invention relates to furniture items. In particular, the present invention relates to furniture items that involve control systems.

### BACKGROUND OF THE INVENTION

The reference in this specification to any earlier publication (or information deduced from it), or to any matter which is known, is not, and shall not be considered as an acknowledgment or any form of proposition that the earlier publication (or information derived from it) or known matter forms part of the general knowledge in the field to which this specification relates.

Existing furniture is typically fixed in shape (or look) and is used for a particular function. In certain less common cases, the furniture, such as a sofa or bed, may contain no more than one or two actuators, which are used to create an incline on the sofa or bed in order to provide the user with a leg rest, a head/back incline on a hospital bed, or to simply provide lifting support to an elderly or disabled user when they need to stand up. These systems come in different shapes, sizes and mechanics, but they all have one thing in common, that is, they all attempt to provide the user with an assisting physiological function by means of displacing the bulk of the furniture to create an incline that supports the legs, head/back or for standing up.

### BRIEF SUMMARY OF THE INVENTION

The present invention seeks to overcome, or at least ameliorate, one or more disadvantages of existing arrangements.

The present invention seeks to provide a new type of furniture arrangement, wherein a single furniture can morph (or change) its overall shape (or look), in a controlled manner, and take the appearance of any number of different furniture looks (or configurations), as desired by the user. Typically, creating a new furniture shape is accomplished with an arbitrarily large (1-dimensional, 2-dimensional and/or 3-dimensional) array of individually adjustable/actuated furniture components, wherein each furniture component is displaced by a particular spatial amount. The present invention seeks to provide a system and method that includes at least one of the following:

Typically, an arbitrarily large array of actuators, arranged in a 1, 2 or 3-dimensional configuration, wherein each actuator is connected to at least one independently adjustable furniture component, in order to move (or displace) that furniture component in a controlled (arbitrary or pre-determined) manner, so to change the furniture from one furniture shape to another, in order to create a new furniture look and/or functionality.

Typically, the individually adjustable furniture components are displaced manually, automatically, or a combination of both. In the case of the automatic control, the actuators are typically controlled by one or more electronics hardware unit(s), where:
a) Typically, an electronics hardware unit is implemented to control more than one, or all of the actuators, in an array of actuators.
b) Typically, each individual actuator is controlled by a dedicated electronics hardware unit, where preferably each electronics hardware unit is situated close to the actuating structure in order to create a modular design.
   The electronic hardware unit typically includes all the necessary electronics for execution of the shape-changing computer program as well as conditioning of all input/output electrical signals.

Typically, the user may choose to keep a particular furniture shape and use it, or decide to change it to another furniture shape, from a very large selection of furniture shapes, which are either pre-programmed or designed as a new shape by the user.

Typically, an arbitrarily large array of sensors may be used to measure various physical properties during the system operation. The measurements can be used for at least one of the following: to create a closed-circuit-feedback loop wherein typically the external pressure is measured and the data is used to alter the furniture shape; and to inform the user of at least one type of physical measurement. Typically, the physical measurement may be at least one of the following: pressure, force, weight, temperature, electric field, magnetic field, electromagnetic field, heat, spatial position, voltage, current, humidity, motion detection, acoustic signal or flow.

Typically, a user-friendly software interface connects the user to the morphing furniture and through which the user can control the furniture and receive data from the morphing furniture. The software can be installed on any existing electronic system that typically contains a visual screen, such as a personal computer, laptop, mobile phone, tablet, etc.

Typically, the connection between the furniture and the user interface can be direct connection via any form of cable(s) or a wireless connection utilizing any existing wireless communication protocol.

Typically, the present invention can be applied to at least one of the following functions: seating, sleeping, resting, exercising, walking, meditating, object holding/storing and/or as decorative art.

Typically, the present invention can therefore be employed as at least one of the following: sofa, bed, table, shelves, chair, stool, desk, flooring, ceiling, stand and/or cupboard.

Whilst the purpose of the present invention is to alter the overall look (or shape) of the single furniture piece by displacing an array of actuated furniture components in a particular manner and thus please the user with the new furniture configuration that is made available to the user, the second accompanying purpose of the present invention is to provide a much larger spectrum of new physiological functionalities than previously available.

### BRIEF DESCRIPTION OF THE SEVERAL VIEWS OF THE DRAWING

FIG. 1A is a schematic cross-sectional diagram of an example of reconfigurable furniture.

FIG. 1B is the same schematic diagram illustrating the displaced furniture components which provide a target shape.

FIG. 2A is a schematic cross-sectional diagram of an example of reconfigurable furniture that also includes a sensor array inside a flexible layer.

FIG. 2B shows displaced furniture components (such as for example: paddings) so to provide a desired overall shape, wherein the flexible sensor array layer stretches to accommodate an overall shape generated by a collective of individual paddings.

FIG. 3A is a schematic cross-sectional diagram of an example of reconfigurable furniture that also includes a sensor array.

FIG. 3B is the same schematic diagram illustrating the displaced furniture components (such as for example: paddings) so to provide a desired overall shape, wherein the individual sensor array layers accompany and move with associated furniture components.

FIG. 4 is an isometric view of an example of the present invention showing a 2-dimensional 8×4 grid-type arrangement of individually driven blocks.

FIG. 5 are isometric views of the present invention showing alternative examples of 2-dimensional block arrangements.

FIG. 6 are isometric views of the present invention illustrating examples of different furniture shapes produced with a single array of 8×4 blocks.

FIG. 7 is a schematic diagram and example of the present invention which shows an array of blocks situated inside a furniture cover and casing, along with a user interface.

FIG. 8A is an isometric view of the present invention showing an example in form of a 2-dimensional 24×12 grid-type arrangement of blocks and

FIG. 8B shows the same blocks morphed into a sofa shape.

FIG. 9 is an example schematic diagram of the present invention showing the electronics hardware unit and its interconnectivity with the individually movable blocks and the external interface unit.

### DETAILED DESCRIPTION OF THE INVENTION

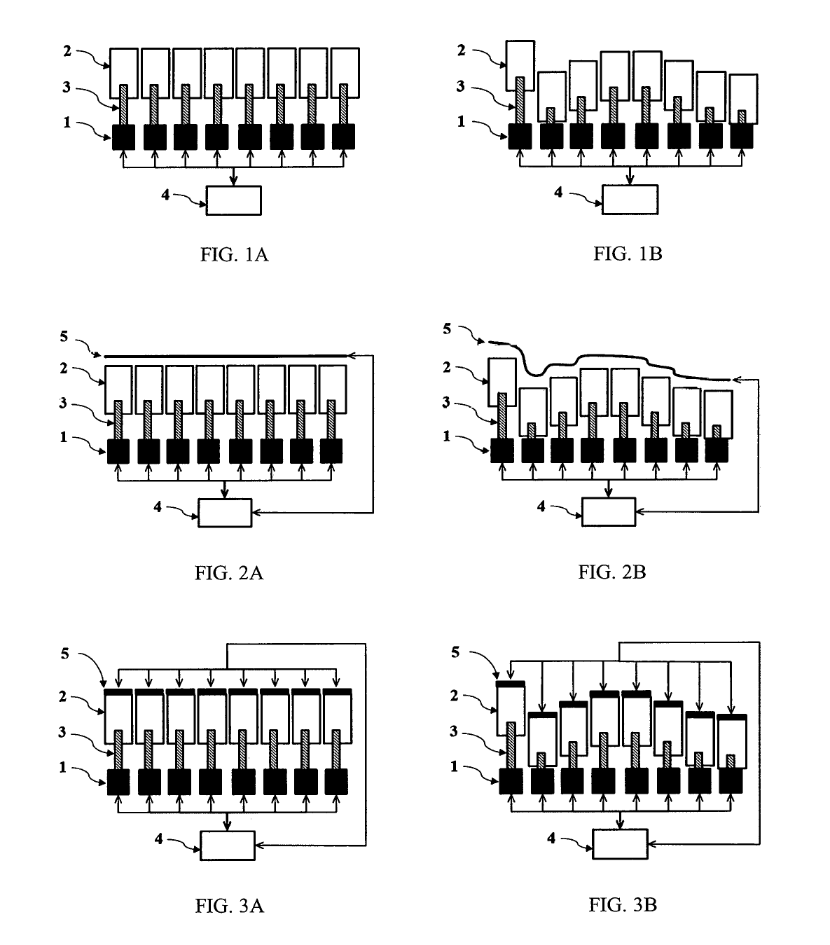

Referring to FIG. 1A, which is a conceptual schematic diagram example in a side view, the present invention includes at least one actuator in an array of independently driven actuators 1, wherein each actuator is attached to a furniture component 2 via a fixture 3. The actuators are driven by a programmable electronics hardware unit 4.

Referring to FIG. 1B, the independently driven actuators are used to purposefully displace the furniture components in different amounts along the vertical direction, so to achieve a desired overall shape of the overall furniture item. The displacement of a furniture component can be achieved in a linear and/or rotational fashion. The actuators 1 can be of at least one of the following types: electric, magnetic, piezoelectric, electromagnetic, hydraulic, pneumatic, mechanical and/or thermal. The actuators 1 can be at least one of the following: linear, rotational or a combination of those two. The actuators can be driven in parallel, in serial or in a combination of those two.

In the present invention, a fixture 3 is a mechanical structure that is used to connect the actuator 1 to a furniture component 2 in a practical manner, so to transfer the desired displacement (in this example: vertical displacement) from the actuator to the furniture component. The furniture component 2 can be at least one of the following: a padding, a cushion, a table section, etc, and it can consist of any type of known material and/or combination of known materials. Typical materials for the padding include but are not necessarily limited to the following types: foams, leather, spring systems, plastics, vinyl, cloth, wool, and metal, just to name a few. The actuators, fixtures and paddings can be of any shape, size and geometric arrangement.

The actuators (along with fixtures and paddings) can be positioned in any desired orientation relative to each other so to provide individual displacements in any vectorial direction of a 3-dimensional Cartesian space. Each component can be moved by an actuator in: any vectorial direction of the 3-dimensional space, any desired yet practical speed, any sequence of motion events and any duration. Same or different kind of actuators, fixtures and paddings can be used in any combination and arrangement as desired.

In a different example of the present invention, a padding 2 may be also directly attached to the actuator 1, without the need of a fixture 3.

Referring to FIG. 2A, a flexible layer 5 containing an array of sensors that can be situated below, inside or on top of the furniture component in order to measure at least one of the following: pressure, force, weight, temperature, electric field, magnetic field, electromagnetic field, heat, spatial position, voltage, current, humidity and flow. The measurement data can be interrogated from the sensor array in parallel, serially, or in any combination of those two, using the same electronics hardware unit 4, or an entirely separate hardware system (not shown). The measurement data can therefore be used as part of a feedback mechanism (or closed circuit system) in order to adjust the positions of the individual paddings and provide the desired spatial shape of the furniture.

In addition, the present invention can be used to inform the user about how long the user was sitting/resting on the furniture, to suggest/warn the user that he/she should do some exercise for optimal health benefits, to measure and inform the user about their body mass etc.

The sensor array can consist of any type of sensor, combination of sensors, 3-dimensional arrangement of sensors, size and shape of sensors, density of sensors, and distribution of sensors (i.e. equidistant, random, etc.). In one example of the present invention, a person sitting or lying on top of the furniture item will exhibit a pressure on the sensor array. The pressure can be measured and/or mapped out and thereby used to adjust the individual positions of the furniture components such as paddings relative to the person by, for example, equilibrating the overall pressure distribution. FIG. 2B shows how the sensor layer can be stretched as the individual paddings are repositioned, depending on the measured and mapped out sensor data.

FIG. 3A is an example of an alternative sensor arrangement, wherein each furniture component such as a padding has an individual sensor array attached to it. All individual sensor array units (for each padding) can be controlled by the electronics hardware unit 4 or an alternative, dedicated hardware system. In an example arrangement of the present invention, and referring to FIG. 3B, individual sensor layers do not need to be necessarily flexible and stretchable in order to conform to the overall shape of the padding array (see FIG. 3B).

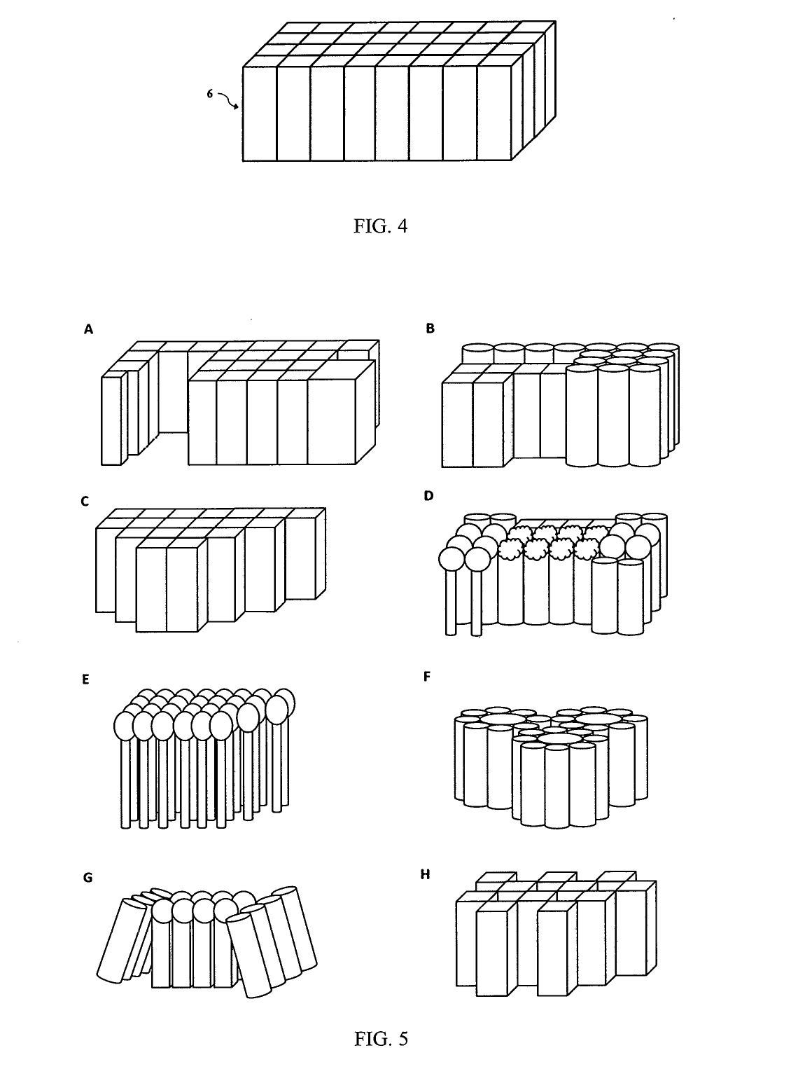

The union of actuators, fixtures and furniture components, is herein referred to as a ‘block’ 6, which can be of any shape, size and type constitution of its sub-elements. It can be appreciated that an array of such blocks can be grouped in any desired 1-, 2-, or 3-dimensional configuration. FIG. 4 is an example of a 2-dimensional configuration wherein the blocks are arranged in a 4×8 grid-type array, with paddings as furniture component. Arbitrarily large array configurations of such blocks are also possible, for example N (for 1-dimensional configuration), N×M (for 2-dimensional configuration) and N×M×V (for 3-dimensional configuration) in size, where N, M and V are positive integers of arbitrary magnitude. It is also feasible to create other type of geometric arrangements of blocks, as illustrated in additional examples of FIG. 5. We therefore note that arbitrarily complex arrangements of different block types, shapes and configurations are possible, including blocks that are arranged at arbitrary angles relative to adjacent blocks (see example FIG. 5G).

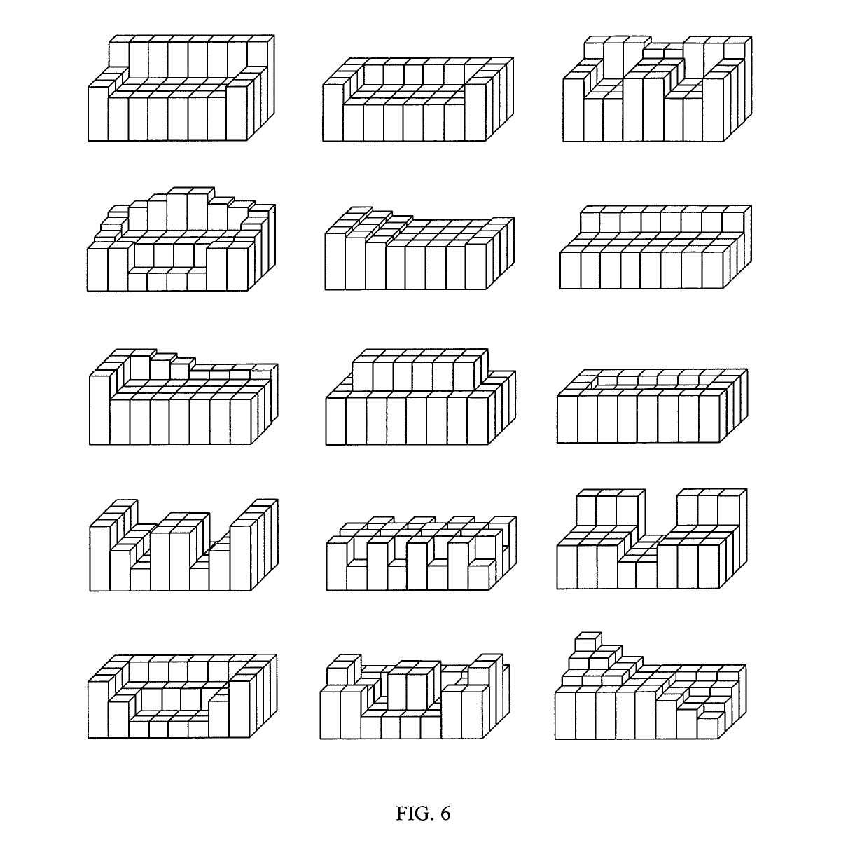

FIG. 6 are examples of the present inventions illustrating a variety of configured (or morphed) furniture shapes based on the 8×4 block arrangement example of FIG. 4. Examples include, single sofas, beds, double seats with leg rests, inclined rests with cushions and further examples include provision of tables amidst the seats, among others. It can be appreciated that an arbitrarily large number of furniture shapes can be created using an array of blocks, wherein actuators are moving and displacing individual furniture component, or combination of furniture components, in a controlled manner.

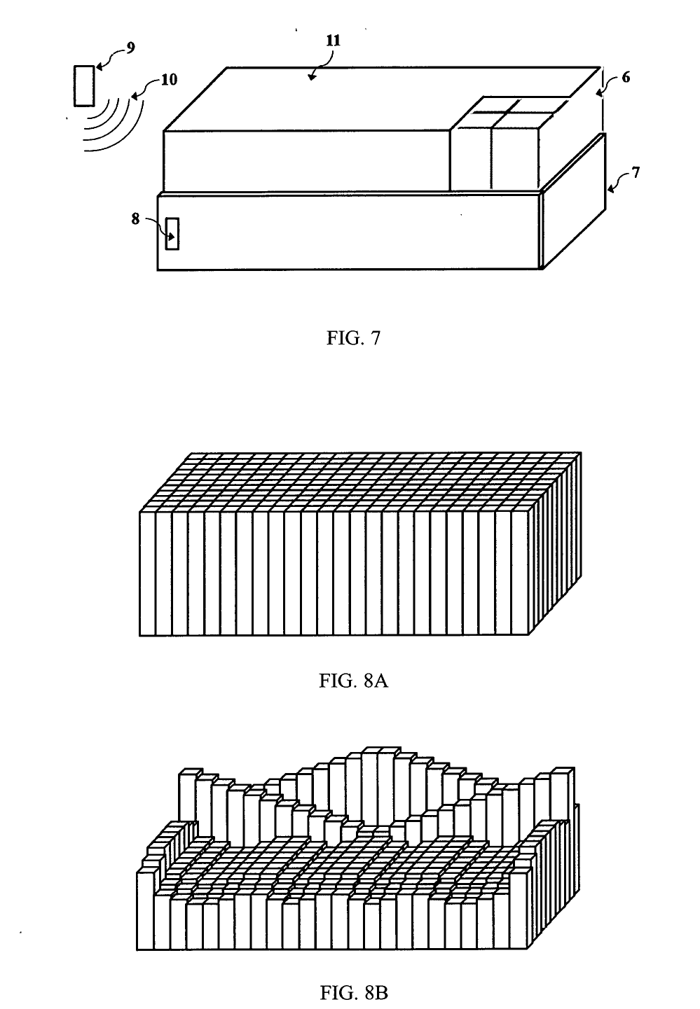

FIG. 7 is an isometric view of an example of the present invention showing the cut-out view of a flexible furniture cover 11 (which may or may not be used) situated over the displaceable furniture components 2 (in this case padding) as well as a sturdy casing 7 that houses the actuators, mechanical fixtures 3 and electronics 4. It is also possible to situate actuators 1 and/or electronic unit(s) 4 outside a cover 7 (i.e. outside the furniture item). The furniture item can also contain a user interface 8, which can be used for at least one of the following example functions: to switch on and off the actuators and/or electronics; to select a furniture shape from a predefined list of programmed shapes; to upload new shapes into the electronics unit via an arbitrary cable connected to an external device 9 and/or arbitrary memory card (such as SD card or USB) plugged into the user interface 8; to design a new shape; to program the time when different shapes are to be executed and in which manner and sequence; to obtain diagnostics on the system; to obtain voice commands from the user etc. It is also possible to achieve all these functions without the user interface 8, by directly providing commands to (as well as retrieving any data from) the electronics unit 4. The same functionality can be also available to the user with/without the user interface 8, by using an external control device 9 which communicates any functions to a furniture item wirelessly by transmitting (Tx) and receiving (Rx) wireless signals 10 (i.e. in form of electromagnetic waves) using an available Tx-Rx protocol. The external device 9 can be at least one of the following examples: a personal computer (PC), a laptop, a mobile phone device, a tablet, a watch, a furniture remote control, a TV, a gaming console, a blackberry, etc. An external device 9 typically has a dedicated software(s) installed which can be used to control the furniture item. Such a software can include a predefined list of shapes. New shapes can be downloaded from a dedicated website, server or cloud and/or be also designed by a user using same software. A software can be installed on the external device 9 and/or be available on internet (accessible through a user account). Furniture shapes can be also shared by different users. This can be accomplished online for example by establishing a user sharing platform, which could also include a publically accessible and shared pool of furniture shapes.

FIG. 8A is an isometric view of the present invention showing an example in form of a 2-dimensional 24×12 grid-type arrangement of blocks that has configured itself into a sofa-type furniture, as shown in FIG. 8B. It can be appreciated from this example that a higher grid resolution can lead to smoother and regular looking furniture shapes.

Consequently, it can be appreciated that the present invention can be used in a wide variety of situations and cases only limited by the imagination of a user. For example, a user or hospital patient lying on the configured bed shape, can have their spine optimally aligned by measuring the body pressure with a sensor array and using measurement data to adjust a set of paddings to a particular or optimal shape. Other optimal (orthopaedic) anatomical alignments are also possible depending on a physiological case. In other examples, where home or office space is limited, the present invention can provide a variety of useful furniture shapes without consuming a large amount of space.

The present invention can also provide a lift to an elderly user when they wish to stand up from a sitting or lying position by elevating some of the paddings in a controlled manner.

In another example, the present invention can be used to provide a table-type platform, which can be used for a large number of purposes. In another example, the present invention can be configured as a two level bed for users (such as children), wherein the edge-paddings on the top level bed can be elevated slightly higher than other paddings so to preclude a person on a top bed from accidentally falling down.

A furniture based on the present invention can be also reconfigured via user voice commands and it can provide a decorative entertainment-type platform which can move (i.e. ‘dance’) in synchrony with, for example, external music or another type of stimuli. In another example, the background sounds of a movie (or visual program) can be synchronized with the present invention to provide certain level of vibration and motion in order to make the movie experience more interactive for the user.

The present invention can therefore find applications in various domestic, institutional and industrial-type applications, which can include at least one of the following examples: aviation industry, hospitals, art museums, night clubs, movie theatres, aged care, homes, TV studios, medical offices, dentistry, psychology, kindergartens, retail shops, restaurants, car industry, just to name a few. The users of the reconfigurable furniture may include both humans and pets, among others.

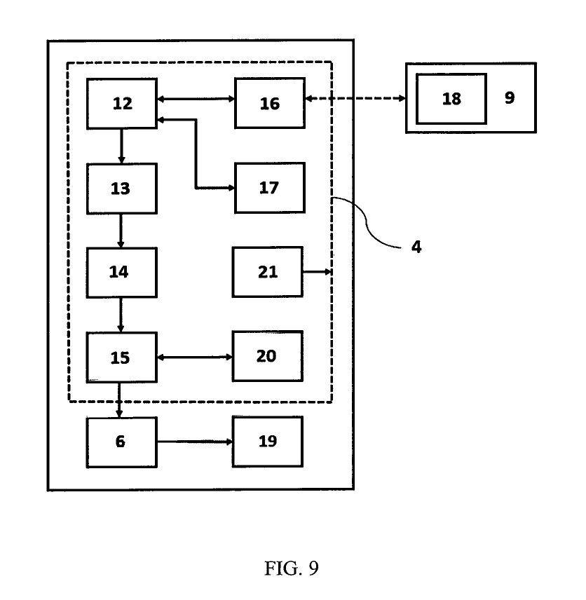

FIG. 9 is an example schematic diagram of the present invention showing the electronics hardware unit 4, which consists of at least one of the following: a digital CPU/microcontroller board 12 with all essential peripheral interfaces such as USB driver integrated circuits (IC), crystal oscillator, memory units, analogue-to-digital (AD) and digital-to-analogue (DA) converters, multiplexers and de-multiplexers, amplifiers, among others; an opto-coupler isolation board 13 that optically isolates the CPU/microcontroller board from the rest of the high-power analogue electronics such as relays and actuators; a relay driver board 14 that provides the required current to switch on/off the relays; a relay (switch) board 15 that is used to control the direction of the power supply current to each and every electromechanical actuator and thus drive the linear actuators to move up or down when needed; an actuator module 6 consisting of at least one linear actuator in an array of actuators, where an actuator is attached to the furniture component that is to be displaced by the actuator; a wireless data transmission/reception card 16, which is used as a communication interface between the CPU/microcontroller board 12 and the external user device 9, which also contains a software program 18 that allows the user to input user-friendly (typically touchscreen) commands and receive data or feedback from the morphing furniture system; a power supply 21 that provides the power to power-needing components within the hardware unit 4; an optional digital or analogue input/output interface 20 that is physically embedded into the morphing furniture so to allow user direct command input and data readout. This may be in form of a keypad, LCD screen, touchscreen, etc; and the individually adjustable furniture components 19 as well as the remaining furniture infrastructure (included in 19) such as, but not limited to: framing, brackets, nuts and bolts, screws, covers, paddings, construction materials and any other material and configuration that forms part of the morphing furniture item.

1. An arbitrarily distributed array of independently driven actuators, consisting of at least one actuator in such an array, wherein each actuator is affixed to and is moving (and thereby displacing) a furniture partition among a plurality of furniture partitions constituting a furniture item, with different furniture partitions displaced by same or different amounts relative to each other, so to create an arbitrarily large number of furniture shapes (or looks), with the same (morphing) furniture item.

2. Apparatus according to claim 1, wherein one or more electronics hardware unit(s) is used to control at least one of the actuators in an array of actuators, where:
c) an electronics hardware unit is implemented to control more than one, or all of the actuators, in an array of actuators
d) each individual actuator is controlled by a dedicated electronics hardware unit, where preferably each electronics hardware unit is situated close to the actuating structure in order to facilitate a modular design.

3. Apparatus according to claim 1, wherein the actuators can be at least one of the following types:
a) linear
b) rotational
c) combination of linear and rotational
d) electric
e) magnetic
f) piezoelectric
g) ultrasonic
h) electromagnetic
i) guide rail
j) lift column
k) current
l) voltage
m) charge
n) hydraulic
o) pneumatic
p) mechanical
q) thermal

4. Apparatus according to claim 1, wherein the actuators are:
(a) of any shape, size, type, configuration, functionality, material constitution, distribution and geometric arrangement, including relative to each other
(b) controlled in parallel, sequentially or in any combination of those two
(c) driven in an arbitrary time sequence of control events.

5. Apparatus according to claim 1, wherein an individual furniture partition is:
(a) of any shape, size, geometry, dimension, type, configuration, functionality, material constitution, distribution and geometric arrangement
(b) displaced along an arbitrary vectorial direction within a 3-dimensional Cartesian space.

6. Apparatus according to claim 1, wherein the invention further comprises of a sensor array, and wherein at least one sensor within such an array, is:
(a) used to provide a closed circuit feedback mechanism
(b) used to obtain measurements that will assist in the driving of the actuators and therefore the furniture partitions in a particular manner
(c) used to obtain physiological and environmental measurements
(d) of any shape, size, type, configuration, functionality, material constitution, distribution and geometric arrangement, including relative to each other

7. Apparatus according to claim 6, wherein at least one of the sensors in the array of sensors is used to measure at least one of the following:
(i) pressure
(ii) force
(iii) mass/weight
(iv) temperature/heat
(v) electric field
(vi) magnetic field
(vii) electromagnetic field
(viii) spatial position
(ix) voltage
(x) current
(xi) impedance
(xii) humidity
(xiii) flow
(xiv) sound/ultrasound/sonar/vibration

8. Apparatus according to claim 6, wherein one or more sensors:
(a) are interrogated in parallel, sequentially or any combination of those two
(b) can be situated in an arbitrary spatial location and arrangement within the furniture item
(c) can be situated below, inside or near the top surface of the furniture partitions, typically within a flexible material layer.

9. Apparatus according to claim 1, wherein arbitrarily large 1-, 2- and 3-dimensional arrays, configurations, as well as geometric arrangements of furniture blocks (i.e. combination of: actuator, furniture partition and furniture fixtures) are possible.

10. Apparatus according to claim 1, further comprising of an external device for purposes of controlling the electronics and ultimately the furniture item, and the external device can be at least one of the following:
a) personal computer (PC)
b) laptop
c) mobile phone device
d) tablet
e) digital watch
f) remote control
g) television set
h) dvd player
i) gaming console
j) blackberry
k) modem
l) internet interface
m) dedicated device
n) any other suitable electronic device

11. Apparatus according to claim 10, wherein an external device can be used to control the morphing furniture directly via one or more arbitrary cables or wirelessly using a wireless transmit-receive protocol, which can be at least one of the following types:
a) digital
b) analogue

12. Apparatus according to claim 10, further comprising of a software, installed on the external device to provide a user interface, and that can be used to perform at least one of the following:
a) switch on/off the electronics/actuators and ultimately the furniture item
b) access and select one or more furniture shapes from a predefined list of programmed furniture shapes
c) control the morphing furniture by executing new furniture shapes
d) allow a user to create new furniture shapes and furniture motion sequences
e) download new furniture shapes
f) upload new furniture shapes
g) share shapes with other users
h) obtain and perform system diagnostics
i) input voice commands from the user
j) measure environmental and/or user's physiological parameters and inform the
user about the measurement
k) provide warnings after prolonged usage of the furniture item (f.e. prolonged
sitting)
l) perform user statistics
m) visualise, process and utilise sensor measurements
n) create, process and execute physiological and orthopaedic parameters
o) provide suggestions and programs to the user (f.e. weight loss program).

13. Apparatus according to claim 1, wherein at least one of actuators in an array of actuators is connected to at least one furniture partition via a dedicated mechanical fixture, which can be of any shape, size, material constitution and arrangement, in order to translate the motion of an actuator to a furniture partition.

14. Apparatus according to claim 1, wherein the actuators, fixtures, furniture components, electronics and any other system components are embedded in a furniture casing and/or cover, which can be of any shape, size, material constitution and/or arrangement.

15. Apparatus according to claim 2, wherein the electronics hardware unit, consists of at least one of the following: computer processing unit, microcontroller board, opto-couplers, relays, power supply(ies) (AC and/or DC), sensors, wireless data transmission/reception cards, amplifiers, switches, analogue-to-digital converters, digital-to-analogue converters, multiplexers/de-multiplexers, casings, memory units, cables, lumped circuits, antennas, crystal oscillators, USB drivers, and any other electronics in contemporary existence.

16. Apparatus according to claim 1, wherein the morphing furniture item can be applied for at least one of the following functions:
a) seating
b) sleeping
c) resting
d) exercising
e) moving
f) supporting
g) walking
h) meditating
i) object holding/storing
j) object moving
k) used as decorative art

17. Apparatus according to claim 1, wherein the morphing furniture item can at least one of the following:
a) sofa
b) couch
c) lounge
d) bed
e) table
f) shelves
g) bar
h) chair
i) stool
j) desk
k) flooring
l) ceiling
m) stand
n) cupboard
o) wine rack
p) any other furniture item in contemporary existence.
